(19) United States
(12) Patent Application Publication
(10) Pub. No.: US 2017/0324689 A1
(43) Pub. Date: Nov. 9, 2017

(54) SYSTEM AND METHOD FOR AUTOMATICALLY CLASSIFYING E-MAIL

(71) Applicant: NHN Entertainment Corporation, Seongnam-si (KR)

(72) Inventors: Changyol BAEK, Seongnam-si (KR); KyoungHwan LEE, Seongnam-si (KR)

(21) Appl. No.: 15/585,144

(22) Filed: May 2, 2017

(30) Foreign Application Priority Data
May 4, 2016 (KR) 10-2016-0055484

(51) Int. Cl. H04L 12/58; G06F 17/30

(52) U.S. Cl. CPC H04L 51/12; G06F 17/30601; H04L 51/18

(57) ABSTRACT

Provided is a task tracking method including identifying a mail that includes at least one piece of mail information among sender information, receiver information, a mail title, and mail content through a message communication tool; recognizing the mail that includes the at least one piece of mail information as a task and tracking the task; and automatically classifying the task based on a preset condition, and displaying the classified task through the message communication tool.

### BACKGROUND OF THE INVENTION

### Field of the Invention

Example embodiments relate to technology for automatically classifying mails, and more particularly, to a method and system for automatic mail box classification.

### Description of Related Art

With the development in technology, such as the Internet and communication equipment, an e-mail accurately and quickly transferrable regardless whether a counter party is located has been currently commercialized. In particular, the development of technology of a mobile communication terminal including a smartphone, a personal digital assistant (PDA), and the like, has allowed a user to transmit and receive e-mails without restriction on a location and a place.

An e-mail does not require separate communication cost and makes it possible to transmit and receive a large amount of information and to accurately and quickly communicate with any one on any place connected to the Internet. Also, with companies more actively exchanging work activities, e-mails are frequently used to share internal activities and a progress state of business carried out in connection with other companies.

Accordingly, there is a need for technology for integrally managing works associated with a task through interaction with e-mails and automatically classifying the e-mails.

### SUMMARY OF THE INVENTION

Example embodiments provide a task tracking method that may identify a mail including at least one piece of mail information among sender information, receiver information, a mail title, and mail content through a message communication tool, may recognize the identified mail as a task and track the task, may automatically classify the task based on a preset condition, and may display the automatically classified task through the message communication tool.

Additional features of the invention will be set forth in the description which follows, and in part will be apparent from the description, or may be learned by practice of the invention.

Example embodiments disclose a task tracking method including identifying a mail that includes at least one piece of mail information among sender information, receiver information, a mail title, and mail content through a message communication tool; recognizing the mail that includes the at least one piece of mail information as a task and tracking the task; and automatically classifying the task based on a preset condition, and displaying the classified task through the message communication tool.

The automatically classifying and the displaying may include automatically creating and recommending a rule for automatic mail classification.

The automatically classifying and the displaying may include not recommending the rule in response to receiving, from a user, an instruction indicating that the user does not desire to apply the rule for automatic mail classification.

The automatically classifying and the displaying may include providing an interface for designating a condition for automatic mail classification, and receiving a condition for automatic mail classification through the interface based on at least one condition among word information included in a title of the mail, sender information of the mail, receiver information of the mail, referrer information of the mail, a presence or an absence of a mail that does not include the user as a referrer of the mail, and a presence or an absence of an attachment file of the mail.

The automatically classifying and the displaying may include providing an interface for designating a condition for automatic mail classification to be visually distinguishable.

The automatically classifying and the displaying may include providing an interface for designating an execution method for automatic mail classification, and designating at least one execution method among whether to move the mail to an existing folder, whether to move the mail to a trash folder, whether to store the mail, whether to process the mail to be read, whether to tag the mail, whether to exclude the mail from a stream, and whether to register the mail as a work through the interface.

The automatically classifying and the displaying may include providing an interface for setting an application range for automatic mail classification.

The automatically classifying and the displaying may include classifying the mail into at least one mail box among inbox, sent items, outbox, a spam folder, and a trash folder, and storing the classified mail, and displaying a list of mails stored in the mail box in response to a selection on the at least one mail box.

The automatically classifying and the displaying may include displaying or not displaying a main text of a selected mail in response to a selection on at least one mail from the list of mails stored in the mail box and based on whether a function of automatically displaying the main text of the selected mail is set.

The automatically classifying and the displaying may include providing an interface for creating a folder for classifying and storing the mail, and creating the folder in response to an input of information for creating the folder through the interface.

Example embodiments also disclose a non-transitory computer-readable medium storing a computer program to implement a task tracking method including identifying a mail that includes at least one piece of mail information among sender information, receiver information, a mail title, and mail content through a message communication tool; recognizing the mail that includes the at least one piece of mail information as a task and tracking the task; and automatically classifying the task based on a preset condition, and displaying the classified task through the message communication tool.

Example embodiments also disclose a task tracking system including an identifier configured to identify a mail that includes at least one piece of mail information among sender information, receiver information, a mail title, and mail content through a message communication tool; a tracker configured to recognize the mail that includes the at least one piece of mail information as a task and to track the task; and a display configured to automatically classify the task based on a preset condition, and to display the classified task through the message communication tool.

The display may be configured to automatically create and recommend a rule for automatic mail classification.

The display may be configured to not recommend the rule in response to receiving, from a user, an instruction indicating that the user does not desire to apply the rule for automatic mail classification.

The display may be configured to provide an interface for designating a condition for automatic mail classification, and to receive a condition for automatic mail classification through the interface based on at least one condition among word information included in a title of the mail, sender information of the mail, receiver information of the mail, referrer information of the mail, a presence or an absence of a mail that does not include the user as a referrer of the mail, and a presence or an absence of an attachment file of the mail.

The display may be configured to provide an interface for designating a condition for automatic mail classification to be visually distinguishable.

The display may be configured to provide an interface for designating an execution method for automatic mail classification, and to designate at least one execution method among whether to move the mail to an existing folder, whether to move the mail to a trash folder, whether to store the mail, whether to process the mail to be read, whether to tag the mail, whether to exclude the mail from a stream, and whether to register the mail as a work through the interface

The display may be configured to provide an interface for setting an application range for automatic mail classification.

The display may be configured to classify the mail into at least one mail box among in box, sent items, outbox, a spam folder, and a trash folder, and to store the classified mail, and to display a list of mails stored in the mail box in response to a selection on the at least one mail box.

The display may be configured to display or not display a main text of a selected mail in response to a selection on at least one mail from the list of mails stored in the mail box and based on whether a function of automatically displaying the main text of the selected mail is set.

The display may be configured to provide an interface for creating a folder for classifying and storing the mail, and to create the folder in response to an input of information for creating the folder through the interface.

According to example embodiments, a task tracking system may provide a classification method suitable for a user by recommending a rule for automatic mail classification based on information of the user through a message communication tool.

Also, according to example embodiments, a task tracking system may perform an automatic mail classification for user convenience by providing an interface for automatic mail classification through a message communication tool

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates an example of a user terminal and a server according to example embodiments.

FIG. 2 illustrates an example of components of a task tracking system according to example embodiments.

FIG. 3 is a flowchart illustrating an example of a task tracking method performed at a task tracking system according to example embodiments.

FIG. 4 illustrates an example of designating, at a task tracking system, a condition for automatic mail classification according to example embodiments.

FIG. 5 illustrates an example of setting, at a task tracking system, an automatic mail classification according to example embodiments.

FIG. 6 illustrates an example of creating, at a task tracking system, a mail according to example embodiments.

FIGS. 7 and 8 illustrate examples of displaying, at a task tracking system, a mail according to example embodiments.

### DETAILED DESCRIPTION OF THE ILLUSTRATED EMBODIMENTS

Example embodiments will be described in detail with reference to the accompanying drawings. These example embodiments will be described in detail for those skilled in the art in order to practice the present disclosure. It should be appreciated that various example embodiments are different but do not have to be exclusive. For example, specific shapes, configurations, and characteristics described in an example embodiment may be implemented in another example embodiment without departing from the spirit and the scope of the present disclosure. In addition, it should be understood that position and arrangement of individual components in each disclosed example embodiment may be changed without departing from the spirit and the scope of the present disclosure. Therefore, a detailed description described below should not be construed as being restrictive. In addition, the scope of the present disclosure is defined only by the accompanying claims and their equivalents if appropriate. Similar reference numerals will be used to describe the same or similar functions throughout the accompanying drawings. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

The terminology used herein is for the purpose of describing example embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements and/or components, but do not preclude the presence or addition of one or more other features, integers, steps, operations, elements, components, and/or groups thereof.

It will be understood that when an element is referred to as being “connected to” another element, it can be directly connected to the other element, or intervening elements may be present.

Also, the term “mail” used herein refers to an email transmitted and/or received over the Internet and thus, the terms “mail” and “email” are interchangeably used.

Hereinafter, example embodiments will be described with reference to the accompanying drawings.

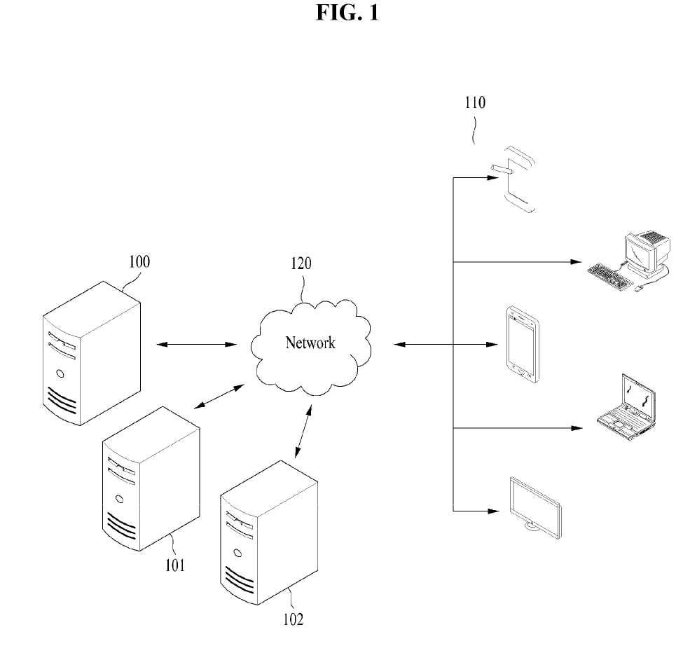

FIG. 1 illustrates an example of a user terminal and a server environment according to example embodiments. Referring to FIG. 1, the network environment includes a user terminal 110, a plurality of servers 100, 101, and 102, and a network 120. FIG. 1 is provided as an example only and thus, the number of user terminals and/or the number of servers are not limited thereto.

The user terminal 110 may be a fixed terminal or a mobile terminal configured as a computer device. For example, the user terminal 110 may be a smartphone, a mobile phone, navigation, a computer, a laptop computer, a digital broadcasting terminal, a personal digital assistant (PDA), a portable multimedia player (PMP), a tablet personal computer (PC), and the like. For example, the user terminal 110 may communicate with other user terminals and/or the servers 100, 101, and/or 102 over the network 120 in a wired communication manner or in a wireless communication manner.

The communication scheme is not particularly limited and may include a communication method that uses a near field communication between devices as well as a communication method using a communication network, for example, a mobile communication network, the wired Internet, the wireless Internet, and a broadcasting network, which may be included in the network 120. For example, the network 120 may include at least one of network topologies that include networks, for example, a personal area network (PAN), a local area network (LAN), a campus area network (CAN), a metropolitan area network (MAN), a wide area network (WAN), a broadband network (BBN), the Internet, and the like. Also, the network 120 may include at least one of network topologies that include a bus network, a star network, a ring network, a mesh network, a star-bus network, a tree or hierarchical network, and the like. However, it is only an example and the example embodiments are not limited thereto.

Each of the servers 100, 101, and 102 may be configured as a computer apparatus or a plurality of computer apparatuses that provides instructions, codes, files, contents, services, and the like through communication with the user terminal 110 over the network 120.

For example, the server 100 may provide a file for installing an application to the user terminal 110 over the network 120. In this case, the user terminal 110 may install the application using the file provided from the server 100. Also, the user terminal 110 may connect to the server 100 and may receive a service or content provided from the server 100 under control of at least one program (for example, a browser or the installed application) and an operating system (OS) included in the user terminal 110. For example, in response to a service request message transmitted from the user terminal 110 to the server 100 over the network 120 under control of the application, the server 100 may transmit a code corresponding to the service request message to the user terminal 110 and the user terminal 110 may configure and display a screen corresponding to the code under control of the application, thereby providing the content to a user.

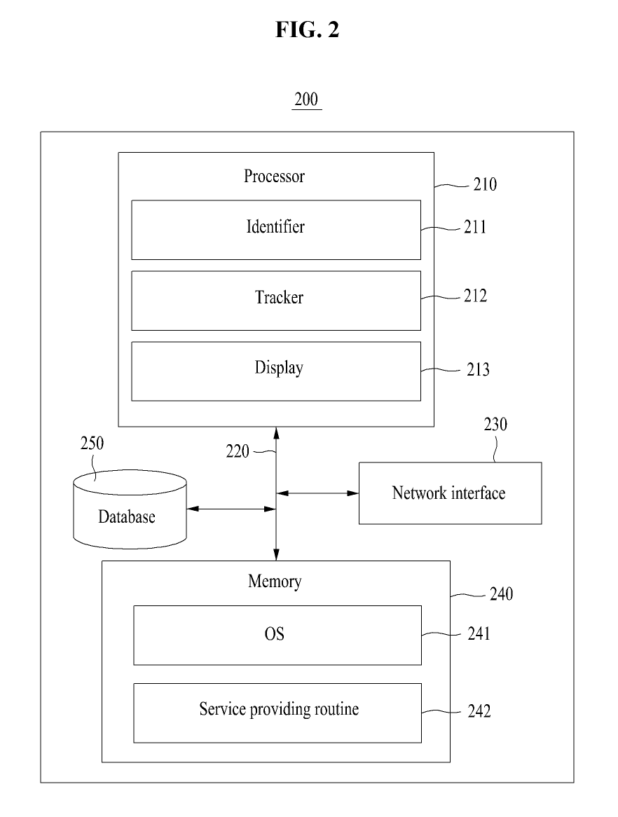

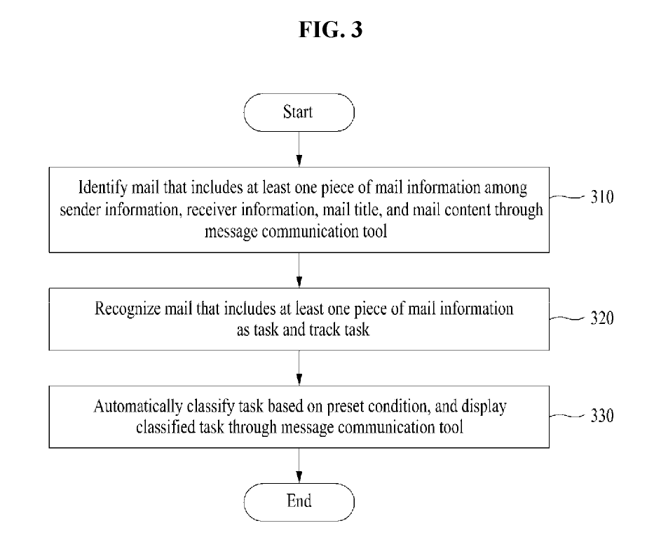

FIG. 2 illustrates an example of components of a task tracking system according to example embodiments, and FIG. 3 is a flowchart illustrating an example of a task tracking method performed at a task tracking system according to example embodiments.

Referring to FIG. 2, a task tracking system 200 may include a processor 210, a bus 220, a network interface 230, a memory 240, and a database 250. The memory 240 may include an OS 241 and a service providing routine 242. The processor 210 may include an identifier 211, a tracker 212, and a display 213. According to other example embodiments, the task tracking system 200 may include a greater or lesser number of components that the number of components shown in FIG. 2. However, there is no need to clearly illustrate many components according to the related art. For example, the task tracking system 200 may include other components, such as a display or a transceiver.

The memory 240 may include a permanent mass storage device such as random access memory (RAM), read only memory (ROM), and a disk drive as a non-transitory computer-readable recording medium. Also, a program code for the OS 241 and the service providing routine 242 may be stored on the memory 240. Software components may be loaded to the memory 240 through another computer-readable recording medium separate from the memory 240 using a drive mechanism (not shown). The other computer-readable recording medium may include, for example, a floppy drive, a disk, a tape, a DVD/CD-ROM drive, a memory card, and the like. According to other example embodiments, software components may be loaded to the memory 240 through the network interface 230 instead of, or in addition to, the computer-readable recording medium.

The bus 220 enables communication and data transmission between the components of the task tracking system 200. The bus 220 may be configured using a high-speed serial bus, a parallel bus, a storage area network (SAN) and/or other appropriate communication technologies.

The network interface 230 may be a computer hardware component for connecting the task tracking system 200 to a computer network. The network interface 230 may be, for example, a network interface card such as an Ethernet card, an optical transceiver, a radio frequency (RF) transceiver, or any type of devices capable of transmitting and receiving information. As another example, the network interface 230 may be a wireless device that includes a mobile computing device, Bluetooth in a universal serial bus (USB), 3rd generation (3G), wireless fidelity (WiFi), and the like. In some example embodiments, a computing device may use the network interface 230 for wireless communication with an external device, such as another networked computing device, a server, or a mobile phone. The network interface 230 may connect the task tracking system 200 to a computer network through a wireless connection or a wired connection.

The database 250 may serve to store and maintain any type of information required to manage information about a project or a task associated with the project. Although FIG. 2 illustrates that the database 250 is constructed in the task tracking system 200, it is provided as an example only. The entire database or a portion of the database may be present as an external database constructed on a separate system depending on a service configuration scheme or an environment, etc.

The processor 210 and the components of the processor 210 may be configured to execute instructions corresponding to a code of at least one program and a code of the OS included in the memory 240. The computer-readable instructions may be provided from the memory 240 or the network interface 230 to the processor 210 through the bus 220. The processor 210 may be configured to execute program codes for the identifier 211, the tracker 212, and the display 213. The program codes may be stored on a storage device such as the memory 240.

The processor 210 and the components of the processor 210 may control the task tracking system 200 to perform operations 310 through 330 included in the task tracking method of FIG. 3. The processor 210 may load a program code for the tack tracking method to the memory 240.

In operation 310, the identifier 210 may identify a mail that includes at least one piece of mail information among sender information, receiver information, a mail title, and mail content through a message communication tool.

In operation 320, the tracker 220 may recognize the mail that includes the at least one piece of mail information as a task and may track the task.

In operation 330, the display 220 may automatically classify the task based on a preset condition, and may display the classified task through the message communication tool. The display 220 may automatically create and recommend a rule for automatic mail classification. The display 220 may not recommend the rule in response to receiving, from a user, an instruction indicating that the user does not desire to apply the rule for automatic mail classification.

The display 220 may provide an interface for designating a condition for automatic mail classification, and receiving the condition for automatic mail classification through the interface based on at least one condition among word information included in a title of the mail, sender information of the mail, receiver information of the mail, referrer information, for example, carbon copy (CC) and blind copy (BC), of the mail, a presence or an absence of a mail that does not include the user as a referrer of the mail, and a presence or an absence of an attachment file of the mail. The display 220 may provide an interface for designating a condition for automatic mail classification to be visually distinguishable.

The display 220 may provide an interface for designating an execution method for automatic mail classification, and may designate at least one execution method among whether to move the mail to an existing folder, whether to move the mail to a trash folder, whether to store the mail, whether to process the mail to be read, whether to tag the mail, whether to exclude the mail from a stream, and whether to register the mail as a work through the interface. The display 220 may provide an interface for setting an application range for automatic mail classification.

The display 220 may classify the mail into at least one mail box among inbox, sent items, outbox, a spam folder, and a trash folder, and may store the classified mail, and may display a list of mails stored in the mail box in response to a selection on the at least one mail box. The display 220 may display or may not display a main text of a selected mail in response to a selection on at least one mail from the list of mails stored in the mail box and based on whether a function of automatically displaying the main text of the selected mail is set.

The display 220 may provide an interface for creating a folder for classifying and storing the mail, and may create the folder in response to an input of information for creating the folder through the interface.

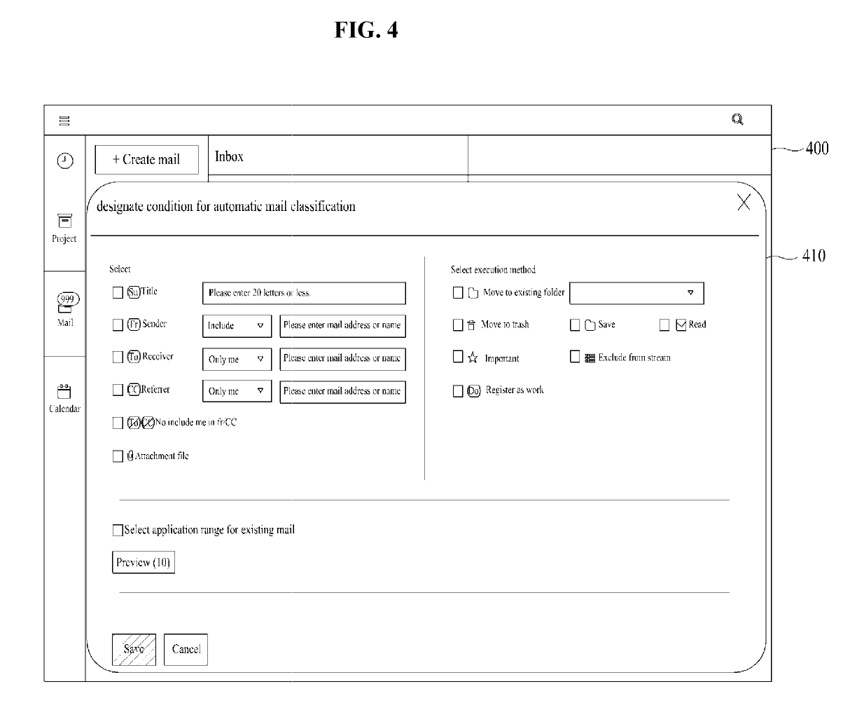

FIG. 4 illustrates an example of designating, at a task tracking system, a condition for automatic mail classification according to example embodiments.

A message communication tool 400, as a tool for performing a collaborative process, may recognize a project and works, mails, messages, a schedule, a task tracker, a messenger, and documents associated with the project as a task and may make them integrally available through interaction thereof. Also, the message communication tool 400 enables collaboration between members participating in each task and enables the members to share a progress state of a corresponding task in real time.

The task tracking system may provide an interface 410 for designating a condition for automatic mail classification to the message communication tool 400. The task tracking system may provide the interface 410 for selecting or inputting word information included in a title of the mail, sender information of the mail, receiver information of the mail, referrer information of the mail, a presence or an absence of a mail that does not include the user as a referrer of the mail, and a presence or an absence of an attachment file of the mail. Here, the task tracking system may provide the condition for automatic mail classification to be visually identifiable.

The user may input the condition for automatic mail classification through the interface 410 provided from the message communication tool 400, based on at least one condition among word information included in a title of the mail, sender information of the mail, receiver information of the mail, referrer information of the mail, a presence or an absence of a mail that does not include the user as a referrer of the mail, and a presence or an absence of an attachment file of the mail.

The user may select the condition for automatic mail classification and may input or select detailed information associated with the selected condition. The task tracking system may receive the selected condition and the detailed information associated with the selected condition from the user. For example, the user may designate, as the condition, the referrer information to include the user alone, and may also directly input a mail address or a name into the referrer information.

The task tracking system may allow an application range to be selectable even with respect to an existing mail based on the condition for automatic mail classification selected by the user. For example, the user may select the application range to be applied to the existing mail based on the condition for automatic mail classification. The condition for automatic mail classification may be applicable to existing mails corresponding to a predetermined previous period.

Also, the task tracking system may provide the interface 410 for designating an execution method for automatic mail classification through the message communication tool 400. Although FIG. 4 illustrates an example of providing an interface for inputting a condition for automatic mail classification and an interface for designating an execution method for automatic mail classification together, each interface may be separately provided.

The task tracking system may provide the interface 410 for designating at least one execution method among whether to move the mail to an existing folder, whether to move the mail to a trash folder, whether to store the mail, whether to process the mail to be read, whether to tag the mail, whether to exclude the mail from a stream, and whether to register the mail as a work through the interface. The user may designate at least one execution method among whether to move the mail to an existing folder, whether to move the mail to a trash folder, whether to store the mail, whether to process the mail to be read, whether to tag the mail, whether to exclude the mail from a stream, and whether to register the mail as a work through the interface through the user interface 410.

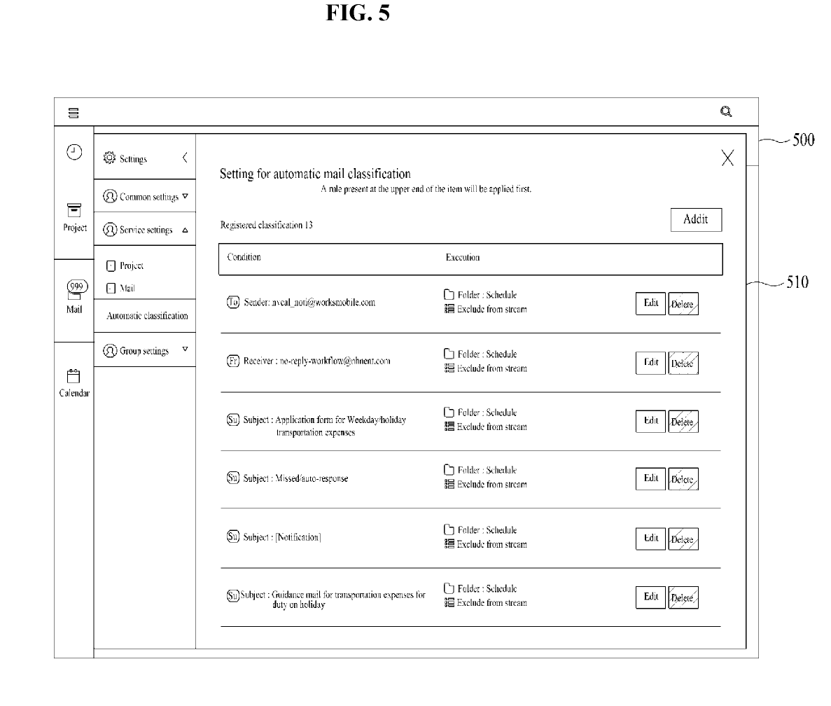

FIG. 5 illustrates an example of setting, at a task tracking system, an automatic mail classification according to example embodiments.

The task tracking system may provide an interface 510 for inputting a setting for automatic mail classification through a message communication tool 500. A user may input the setting for automatic mail classification through the interface 510.

The task tracking system may automatically classify the mail in response to preset information being included in, for example, a sender of the mail, a receiver of the mail, a referrer, for example, BC and CC, of the mail, a title of the mail, etc., through the interface 510 for inputting the setting for automatic mail classification through the message communication tool 500. For example, the user may set a mail to be automatically classified into a folder with a folder name of ‘schedule’ and to be excluded from a stream, if ‘schedule’ is included in the title of the mail. Here, the user may correct or delete the set condition and may also add a new condition for automatic mail classification.

The task tracking system may automatically create and recommend a rule for automatic mail classification. The task tracking system may automatically create the rule for automatic mail classification based on a preset condition. For example, the task tracking system may classify mails of inbox by sender, and if a predetermined rate, for example, 20% or more of the mails are classified, may recommend a sender-based classification rule. Alternatively, the task tracking system may classify mails of inbox based on a title similarity, for example, words corresponding to similar categories, and if a predetermined rate or more of the mails are classified, may recommend a similarity-based classification rule. Alternatively, the task tracking system may recommend a rule for extracting a specific portion from a title of a mail and classifying the mail based on the extracted specific portion.

The task tracking system may provide a classification method suitable for the user by recommending the rule for automatic mail classification based on information of the user, for example, mail use information of the user, mail classification information of the user, etc., through the message communication tool 500. The user may use a user friendly mail box classification by applying the rule recommended by the task tracking system.

In response to receiving, from the user, an instruction indicating that the user does not desire to apply the rule for automatic mail classification, the task tracking system may not recommend the rule. Here, if the user does not desire the recommended rule, the recommended rule may be excluded from the future recommendation.

The task tracking system may display a classification condition to be visually distinguishable from automatic mail classification settings displayed on the message communication tool 500. For example, the task tracking system may display a sender as ‘fr’, a sender as ‘to’, and a title of the mail as ‘Su’.

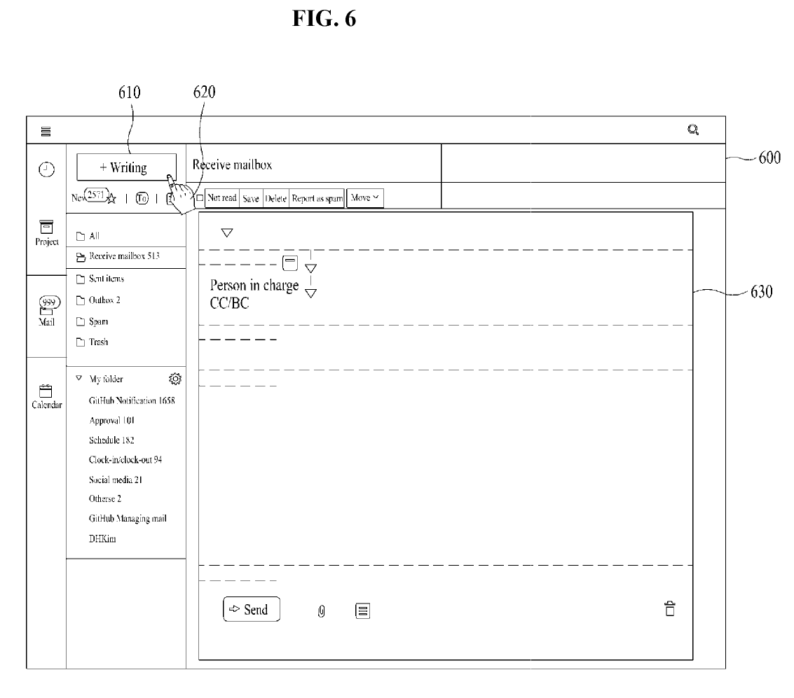

FIG. 6 illustrates an example of creating, at a task tracking system, a mail according to example embodiments.

Referring to FIG. 6, the task tracking system may provide an interface 610 for creating a mail through a message communication tool 600. A user 620 may select the interface 610 for creating a mail through the message communication tool 600. The task tracking system may provide a mail layer 630 in response to the user 620's selection on the interface 610 for creating a mail. Here, the mail layer 630, as an interface for creating a mail, may be provided so that the user 620 may input a mail title, a sender, a receiver, referrer, mail content, an attachment file, and the like. In response to an input from the user 620 on at least one of the mail title, the sender, the receiver, the referrer, the mail content, and the attachment file, the mail may be transmitted. For example, the user 620 may transmit a mail regarding a project or a task associated with the project through the mail layer 630. The task tracking system may call information about a task recognized at the message communication tool 600, may attach the called information to a mail, and may transmit the mail with the attached information.

The task tracking system may transmit a mail to a receiver and a referrer based on information input from the user 620. The receiver and the referrer of the mail may receive the mail from a mail box of the message communication tool 600. Also, a sender of the mail may view details of the mail from sent items of the message communication tool 600.

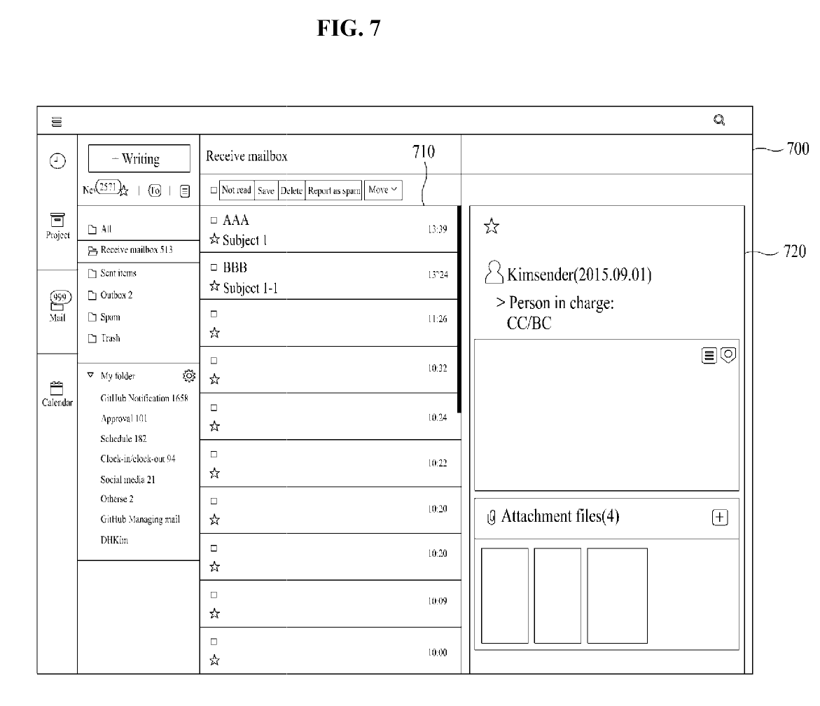

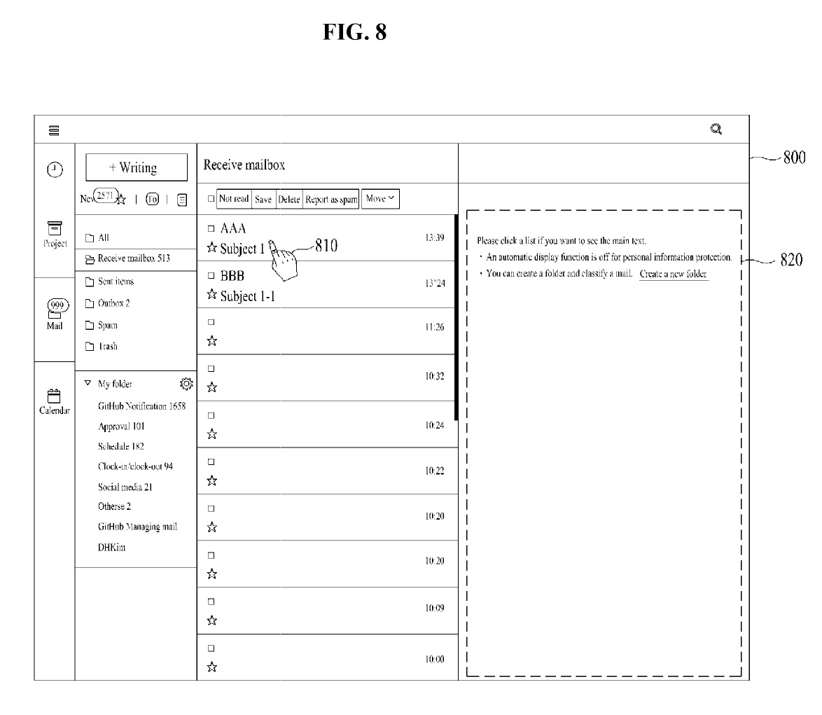

FIGS. 7 and 8 illustrate examples of displaying, at a task tracking system, a mail according to example embodiments.

The task tracking system, as a system for recognizing a project and works, mails, messages, a schedule, a task tracker, a messenger, and documents as a task, and enabling collaboration through interaction between tasks, may provide a project, tasks associated with the project, a mail, a calendar, and the like to be available through a message communication tool.

Referring to FIGS. 7 and 8, the task tracking system may automatically classify a transmitted or received mail and may display the classified mail through a message communication tool 700, 800. The task tracking system may provide a mail folder that includes all of the sent and received mails, inbox for storing a received mail, sent items for storing a sent mail, outbox for temporarily storing a mail, a spam folder for storing a spam mail, and a trash folder for storing a deleted mail.

A user may select at least one mail box. The message communication tool 700, 800 may display a list of mails on a mail area 710 included in the selected mail box. For example, in response to the selection of the user on inbox, mails stored in inbox of the message communication tool 700, 800 may be displayed.

Based on a type of a selected mail box, the task tracking system may display a time at which each of mails stored in the selected mail box is transmitted, temporarily stored, or received, a title of the mail, a sender of the mail, a receiver of the mail, an importance of the mail, and the like. An importance may be applied to the message communication tool 700, 800 in such a manner that the user checks an importance of each of the mails stored in each mail box.

In response to a selection on at least one mail from a list of mails stored in a mail box, the task tracking system may display a main text 720 of the selected mail. Here, the main text 720 of the mail may include a sender, a receiver, a referrer, mail content, an attachment file, a sent date, etc., of the mail.

An example of not displaying, at the task tracking system, a main text of a mail for personal information protection will be described with reference to FIG. 8.

In response to a selection on at least one mail from a list of mails stored in inbox, the task tracking system may display or may not display a main text of the selected mail based on whether a function of automatically displaying the main text is set to the selected mail. In response to a user's setting not to automatically display the main text of the mail, the main text of the selected mail may not be displayed.

The task tracking system may set a main text of a mail not to be displayed as a default value. Alternatively, the task tracking system may set the main text not to be displayed with respect to mails corresponding to a preset criterion. For example, the task tracking system may determine that the mail content requires confidentiality and may set the main text of the mail not to be displayed, and may not display the main text based on a variety of criteria such as if the mail includes a preset word, if the mail includes a specific receiver, and the like.

For example, referring to FIG. 8, when it is assumed that a user 810 selects inbox, the task tracking system may display a list of mails stored in the inbox through the message communication tool 800. The user 810 may select at least one mail from the list of mails. The task tracking system may not display a main text of the selected mail.

Also, the task tracking system may provide an interface 820 for creating a folder. The user 810 may create the folder by inputting a name of the folder through the provided interface 820. The task tracking system may display the folder with the name input from the user 810 on the message communication tool 800. Here, the user 810 may correct the name of the folder, may create or delete the folder, and may create a plurality of folders.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instruction or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present disclosure, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments.

While certain example embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A task tracking method comprising:
identifying a mail that includes at least one piece of mail information among sender information, receiver information, a mail title, and mail content through a message communication tool;
recognizing the mail that includes the at least one piece of mail information as a task and tracking the task; and
automatically classifying the task based on a preset condition, and displaying the classified task through the message communication tool.

2. The task tracking method of claim 1, wherein the automatically classifying and the displaying comprises:
automatically creating and recommending a rule for automatic mail classification.

3. The task tracking method of claim 2, wherein the automatically classifying and the displaying comprises:
not recommending the rule in response to receiving, from a user, an instruction indicating that the user does not desire to apply the rule for automatic mail classification.

4. The task tracking method of claim 1, wherein the automatically classifying and the displaying comprises:
providing an interface for designating a condition for automatic mail classification, and receiving a condition for automatic mail classification through the interface based on at least one condition among word information included in a title of the mail, sender information of the mail, receiver information of the mail, referrer information of the mail, a presence or an absence of a mail that does not include the user as a referrer of the mail, and a presence or an absence of an attachment file of the mail.

5. The task tracking method of claim 1, wherein the automatically classifying and the displaying comprises:
providing an interface for designating a condition for automatic mail classification to be visually distinguishable.

6. The task tracking method of claim 1, wherein the automatically classifying and the displaying comprises:
providing an interface for designating an execution method for automatic mail classification, and designating at least one execution method among whether to move the mail to an existing folder, whether to move the mail to a trash folder, whether to store the mail, whether to process the mail to be read, whether to tag the mail, whether to exclude the mail from a stream, and whether to register the mail as a work through the interface.

7. The task tracking method of claim 6, wherein the automatically classifying and the displaying comprises:
providing an interface for setting an application range for automatic mail classification.

8. The task tracking method of claim 1, wherein the automatically classifying and the displaying comprises:
classifying the mail into at least one mail box among inbox, sent items, outbox, a spam folder, and a trash folder, and storing the classified mail, and displaying a list of mails stored in the mail box in response to a selection on the at least one mail box.

9. The task tracking method of claim 8, wherein the automatically classifying and the displaying comprises:
displaying or not displaying a main text of a selected mail in response to a selection on at least one mail from the list of mails stored in the mail box and based on whether a function of automatically displaying the main text of the selected mail is set.

10. The task tracking method of claim 1, wherein the automatically classifying and the displaying comprises:
providing an interface for creating a folder for classifying and storing the mail, and creating the folder in response to an input of information for creating the folder through the interface.

11. A non-transitory computer-readable medium storing a computer program to implement a task tracking method, wherein the task tracking method comprises:
identifying a mail that includes at least one piece of mail information among sender information, receiver information, a mail title, and mail content through a message communication tool;
recognizing the mail that includes the at least one piece of mail information as a task and tracking the task; and
automatically classifying the task based on a preset condition, and displaying the classified task through the message communication tool.

12. A task tracking system comprising:
an identifier configured to identify a mail that includes at least one piece of mail information among sender information, receiver information, a mail title, and mail content through a message communication tool;
a tracker configured to recognize the mail that includes the at least one piece of mail information as a task and to track the task; and
a display configured to automatically classify the task based on a preset condition, and to display the classified task through the message communication tool.

13. The task tracking system of claim 12, wherein the display is configured to automatically create and recommend a rule for automatic mail classification.

14. The task tracking system of claim 13, wherein the display is configured to not recommend the rule in response to receiving, from a user, an instruction indicating that the user does not desire to apply the rule for automatic mail classification.

15. The task tracking system of claim 12, wherein the display is configured to provide an interface for designating a condition for automatic mail classification, and to receive a condition for automatic mail classification through the interface based on at least one condition among word information included in a title of the mail, sender information of the mail, receiver information of the mail, referrer information of the mail, a presence or an absence of a mail that does not include the user as a referrer of the mail, and a presence or an absence of an attachment file of the mail.

16. The task tracking system of claim 12, wherein the display is configured to provide an interface for designating a condition for automatic mail classification to be visually distinguishable.

17. The task tracking system of claim 12, wherein the display is configured to provide an interface for designating an execution method for automatic mail classification, and to designate at least one execution method among whether to move the mail to an existing folder, whether to move the mail to a trash folder, whether to store the mail, whether to process the mail to be read, whether to tag the mail, whether to exclude the mail from a stream, and whether to register the mail as a work through the interface.

18. The task tracking system of claim 17, wherein the display is configured to provide an interface for setting an application range for automatic mail classification.

19. The task tracking system of claim 12, wherein the display is configured to classify the mail into at least one mail box among in box, sent items, outbox, a spam folder, and a trash folder, and to store the classified mail, and to display a list of mails stored in the mail box in response to a selection on the at least one mail box.

20. The task tracking system of claim 19, wherein the display is configured to display or not display a main text of a selected mail in response to a selection on at least one mail from the list of mails stored in the mail box and based on whether a function of automatically displaying the main text of the selected mail is set.

21. The task tracking system of claim 12, wherein the display is configured to provide an interface for creating a folder for classifying and storing the mail, and to create the folder in response to an input of information for creating the folder through the interface.
